(19) United States
(12) Patent Application Publication
(10) Pub. No.: US 2022/0066235 A1
(43) Pub. Date: Mar. 3, 2022

(54) INTERCHANGEABLE OVER PRESCRIPTION EYEWEAR

(71) Applicant: Gary Martin Zelman, Thousand Oaks, CA (US)

(72) Inventor: Gary Martin Zelman, Thousand Oaks, CA (US)

(21) Appl. No.: 17/008,471

(22) Filed: Aug. 31, 2020

(51) Int. Cl. G02C 7/02; G02C 5/22

(52) U.S. Cl. CPC G02C 7/02; G02C 2200/02; G02C 2200/08; G02C 5/22

(57) ABSTRACT

The present design includes eyewear including an eyewear chassis comprising two openings and receiving elements formed in the eyewear chassis, the receiving elements firmly and securely receiving a rotatable element connectable to a facia plate maintaining a removable pair of lenses. In some embodiments, rotating the removable pair of lenses from a fully closed position away from the eyewear chassis causes the facia plate to receive upward force to raise the removable pair of lenses to a fully open position, and from the fully open position toward the eyewear chassis causes the facia plate to receive downward force to lower the removable pair of lenses to the fully closed position. One lens of the removable pair of lenses in an embodiment fits within at least one milled recessed inner edge formed within one of the two openings when the removable pair of lenses is in the fully closed position.

### BACKGROUND OF THE INVENTION

### Field of the Invention

The present design relates to eyewear, and more specifically, to “fit over” eyewear, i.e. eyewear that fits over an existing pair of eyeglasses and employs interchangeable lenses.

### Description of the Related Art

Many people purchase and use prescription eyewear. People sometimes find themselves in areas with excessive glare, for example, and would like to use their current eyewear without suffering the effects resultant from glare, lighting variations, and so forth. This is particularly the case when the user has eye sensitivity or is of advanced age.

Past solutions have included clip on eyewear, but such solutions must fit the user's eyewear and clip-on attachments can easily be misplaced or lost. Users can purchase prescription sunglasses or prescription non-clear lenses, but costs of prescription eyewear can be significant and offer a single color of lenses. Other solutions include so-called “fit over” eyewear, where the user places lenses over his or her existing prescription glasses, where the fit over eyewear tends to be relatively large such that the fit-over eyewear can fit over many types of prescription eyewear. However, fit-over eyewear is limited again in that only one set of lenses is offered.

Users sometimes desire green sunglass lenses, other times different colors such as yellow or red, or different polarizations may be desired. However, previous eyewear has been limited in this regard, particularly in the field of fit-over eyewear, as users have been offered one set of lenses per set of fit-over eyewear. Users wanting more lens options in fit-over eyewear have been forced to purchase additional eyewear.

Certain solutions have been proposed but offer limited capabilities. For example, certain replaceable flip-up lens solutions have been proposed, but such devices either offer a continuous rotational movement arc, which can wear out after normal use over a period of time, or include limited ratcheting capabilities, such as ratcheting to multiple fixed positions such that a user wishing to raise lenses must rotate the lenses through numerous ratchet positions. Such designs can be inconvenient and undesirable.

It would be advantageous to offer eyewear that can be used with existing prescription eyewear or clear eyewear that allows users to employ different lenses over such clear or prescription eyewear that avoids the issues present in prior designs.

### SUMMARY OF THE INVENTION

The present design includes eyewear comprising an eyewear chassis comprising two openings and receiving elements formed in the eyewear chassis, the receiving elements configured to firmly and securely receive a rotatable element connectable to a facia plate configured to maintain a removable pair of lenses. In some embodiments, rotating the removable pair of lenses from a fully closed position away from the eyewear chassis causes the facia plate to receive upward force to raise the removable pair of lenses to a fully open position and rotating the removable pair of lenses from the fully open position toward the eyewear chassis causes the facia plate to receive downward force to lower the removable pair of lenses to the fully closed position. In one embodiment, one lens of the removable pair of lenses fits within at least one milled recessed inner edge formed within one of the two openings when the removable pair of lenses is in the fully closed position.

According to a further embodiment of the present design, there is provided eyewear for use with a removable pair of lenses comprising an eyewear chassis comprising two openings and receiving elements formed in the eyewear chassis configured to firmly and securely receive a rotatable element connectable to a facia plate configured to maintain the removable pair of lenses. In some embodiments, rotating the removable pair of lenses away from the eyewear chassis causes application of upward force to the facia plate toward a fully open position and rotating the removable pair of lenses toward the eyewear chassis causes application of downward force to the facia plate toward a fully closed position. In some embodiments, one lens of the removable pair of lenses fits within at least one recessed inner edge formed within one of the two openings when the removable pair of lenses is in the fully closed position.

According to a further embodiment of the present design, there is provided eyewear for use with a removable pair of lenses comprising an eyewear chassis comprising two openings and a cam shaft and a facia plate connected to the removable pair of lenses. In some embodiments, rotating the removable pair of lenses away from the cam shaft results in the facia plate being forced upward away from the cam shaft, and wherein rotating the removable pair of lenses toward the cam shaft results in the facia plate being forced downward toward the cam shaft. In some embodiments, one lens of the removable pair of lenses fits within at least one recessed inner edge formed within one of the two openings when the removable pair of lenses is in a fully closed position.

These and other advantages of the present design will become apparent to those skilled in the art from the following detailed description of the invention and the accompanying drawings.

### BRIEF DESCRIPTION OF THE DRAWINGS

The present design is illustrated by way of example, and not by way of limitation, in the figures of the accompanying drawings and in which like reference numerals refer to similar elements and in which:

FIG. 1 is a general overview of one embodiment of the current design;

FIG. 2 shows a rear view of an embodiment of a facia plate including a rotating element and magnet;

FIG. 3 illustrates a front view of a facia plate with lenses provided;

FIG. 4 is a side view of an embodiment of the present design with lenses in the closed position at the beginning of an opening operation;

FIG. 5 is a side view of an embodiment of the present design showing the lenses at an intermediate approximately 50 degree position;

FIG. 6 is a side view of an embodiment of the present design showing the lenses in the fully open position;

FIG. 7 shows a side view of an embodiment of the present design with lenses in the full open position at the beginning of a closure operation;

FIG. 8 is a side view of an embodiment of the present design showing the lenses at an intermediate approximately 50 degree position;

FIG. 9 is a side view of an embodiment of the present design showing the lenses in the fully closed position, with the magnets attracting one another;

FIG. 10 illustrates a first embodiment of a mask element usable with the present design;

FIG. 11 is a second embodiment of a mask element usable with the present design;

FIG. 12 is a further embodiment of a mask element usable with the present design;

FIG. 13 shows an alternate embodiment including a snap on component with magnifying lenses and lighting elements;

FIG. 14 is an alternate view of the embodiment including a snap on component having magnifying lenses and lighting elements; and

FIG. 15 is a front view of the embodiment including a snap on component with magnifying lenses and lighting elements employing the chassis of FIG. 1.

### DETAILED DESCRIPTION

The following description and the drawings illustrate specific embodiments sufficiently to enable those skilled in the art to practice the systems and methods described. Other embodiments may incorporate structural, logical, process and other changes. Examples merely typify possible variations. Individual elements and functions are generally optional unless explicitly required, and the sequence of operations may vary. Portions and features of some embodiments may be included in, or substituted for, those of others.

The present design is a set of fit-over eyewear, sized to fit over standard prescription eyeglasses and having an ability to interchange lenses using a unique construction including a ratcheted rotating element. The eyewear includes a fit-over frame or chassis free of lenses wherein the user can freely substitute different desired lenses, and the user can flip the lenses upward to a desired position using a ratcheted cam arrangement. In one aspect, the unique cam design provides that movement beyond an intermediate position in either direction, up or down, results in application of a level of force to promote positioning the lenses in a full open or full closed position. The design includes a milled out or recessed inner edge that enables each set of desired lenses to fit tightly with the fit-over eyewear chassis such that no light passes through to the user's eyes. Such functionality, providing an optical seal between lenses and frame, is greatly beneficial. A magnet arrangement is provided to further secure the lenses to the frame of the eyewear.

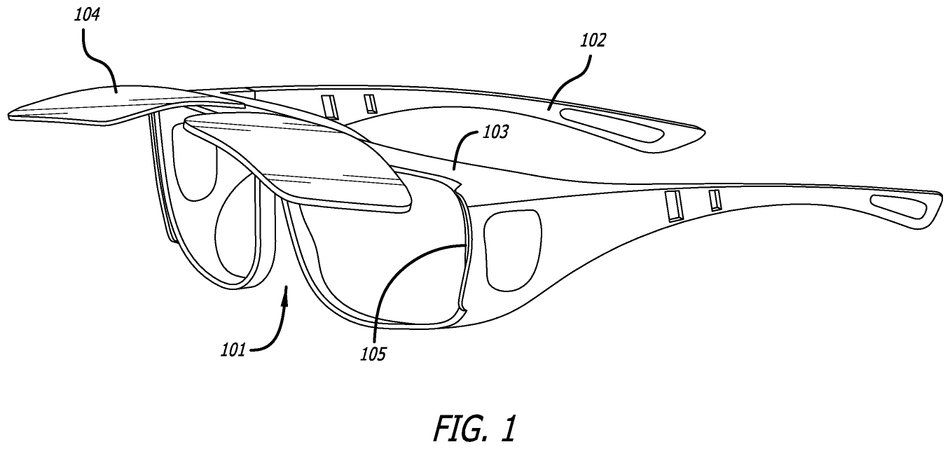

FIG. 1 illustrates one aspect of the overall design. From FIG. 1, there is provided a set of eyewear 101 including two temple pieces, such as temple piece 102, frame 103, and upward rotating lenses 104. Lenses are not fixedly mounted within frame 103, and as can be seen the frames comprise enclosed rims, i.e. the rims are typically not open at the top, bottom, or sides. Open frames may be employed with the design disclosed herein. The upward rotating lenses are interchangeable, and different lenses—prescription, selected color, (green, red, yellow, etc.) may be swapped for different lenses. Frames may be constructed of any appropriate material, including but not limited to plastic and polymers.

In operation, as described below, in certain embodiments the rotating lenses operate to provide a specialized ratcheting feature that enable the lenses to be opened to a single intermediate position, a completely open position, and a completely closed position. The upward rotating lenses of FIG. 1 are shown in a completely open position. The present design includes a cam system that causes the lenses to move toward the full open or full closed position when rotated slightly upward or downward from an intermediate position.

While a particular shape of eyewear is shown in FIG. 1, the eyewear may take on different forms with differing dimensions or curvatures while still embodying the improvements and features provided herein. In one embodiment, the side or lateral edge of the chassis or frame 103 may be milled out such that the lenses fit into the milled edge. One such edge that has been milled out is shown as milled inner edge 105, positioned on the outer side of one lens area, namely the left lens area in this view. In other arrangements, bottom or other edges or partial inside edges of the eyewear chassis may be milled out to provide a secure fit. Such an edge may be considered an indentation, a groove, a channel, or other construct that generally runs across the bottom and/or along the outer side of the lens opening. Such milling and construction enables the lenses when in place to form a relatively secure seal with the chassis such that light does not enter between the lenses and the chassis. Further, the presence of magnets, discussed in detail below, may be used to secure the lenses within the milled slot, groove, or edge such that no light goes through and a stable structure forms when magnets are connected and the lenses are locked in place. Such a groove or indentation may be provided where necessary and appropriate, including but not limited to the outer side of the frame lens area, inner side, top, and/or bottom of the frame lens area. The recess may be provided on any number of inner edges of each lens opening, namely in a generally rectangular lens arrangement, an indentation, recess, groove, or other similar feature may be provided on one, two, three, or four inner edges, and such an indentation, recess, groove, or similar feature may be provided on curved or other edges of lens areas. Indentations, grooves, or milled edges do not need to traverse entire edges, but may be provided on partial inner edges, namely one or more partial inner edges, of the fit-over eyewear chassis.

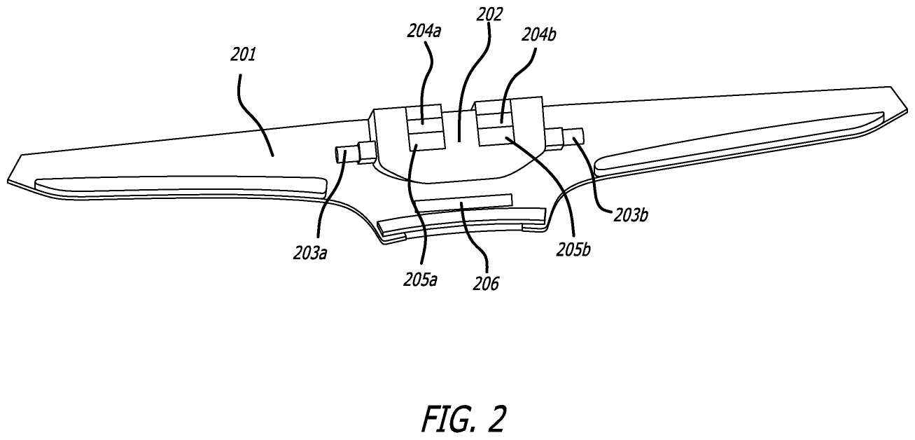

FIG. 2 illustrates a facia plate 201 employed with an embodiment of the eyewear, with a rotating element 202 provided that provides a connection to the frames (not shown in this view) and enables rotation when snapped into the eyewear. Prongs 203a and 203b are provided to be received by corresponding receiving elements, or a single element, located on the eyewear frame. Also provided are internal prongs 204a and 204b that are received in the two central receiving elements 205a and 205b. The design further includes magnet 206, used to receive a complementary magnet provided on the frames, thereby securing the lenses in place when positioned adjacent the frames. Lenses are typically provided with facia plate 201 but are not illustrated in this representation.

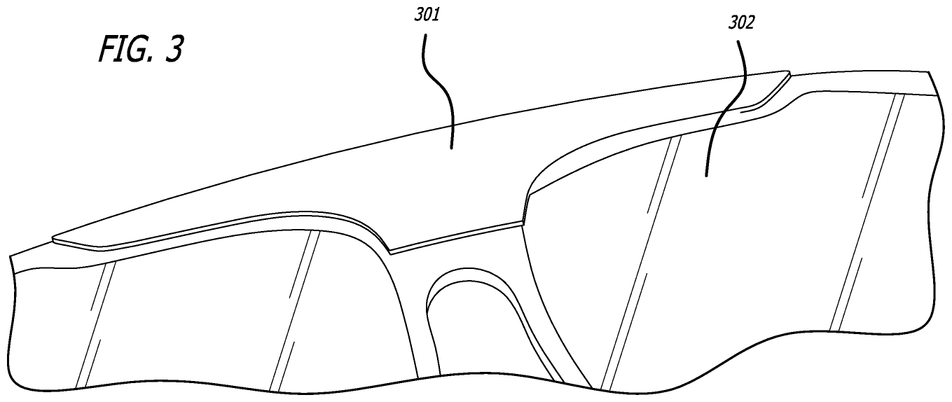

FIG. 3 shows the outside 301 of the facia plate, with the facia plate attached to the frames. Lenses including lens 302 are shown, and the device is snapped into place with the magnets, including one associated with the facia plate and a complementary magnet provided on the frames.

The rotating element snaps into both the facia plate and the frames and allows the user to flip the lenses to either a sole or single intermediate position or a full retracted position in an orientation at approximately 90 degrees from front surface of the frames, upward and out of the way. Magnet 303 is shown and is of one polarity, while a magnet of opposite polarity is provided on the base to enable the facia plate 301 and lenses to “snap” into place and stay in position.

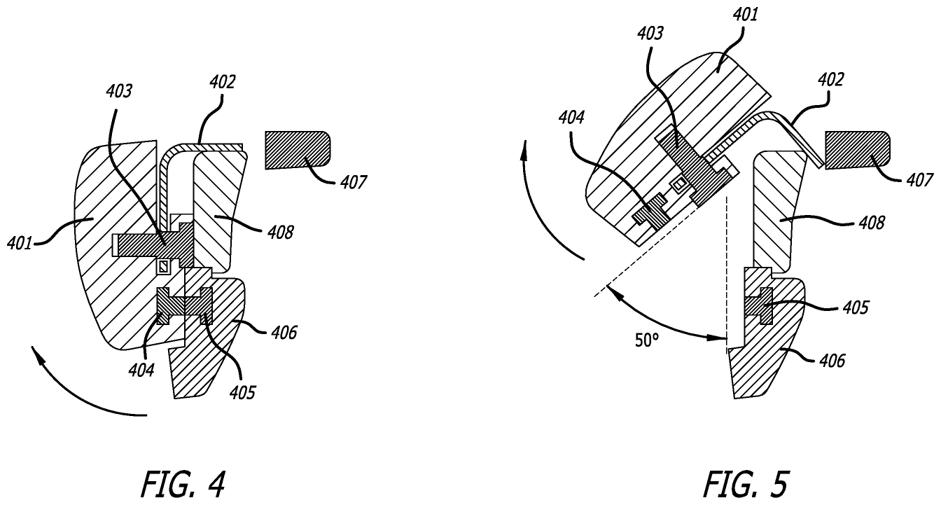

FIG. 4 illustrates a representative side view of the design. From FIG. 4, a piece, referred to herein as flexible L-shaped piece 402 is affixed to lenses 401 by screw 403. Flexible L-shaped piece 402 may be flexible or rigid but is typically flexible. Lens magnet 404 is of a first polarity, while frame magnet 405 is of opposite polarity such that the two magnets attract and secure the lenses into place on the frames. L-shaped piece 402 may be made from any appropriate material, strong enough to maintain the lenses but having a level of flexibility to allow for rotation over cam 408. A flexible type of metal or polymer may be employed. In one embodiment, the L-shaped piece 402 is the facia plate referenced herein.

Upper chassis element 407 and lower chassis element 406 are portions of the frames. Cam element 408, also called a cam shaft, is not considered a portion of the frame, but a rotation element, functioning in a manner similar to rotating element 202 in FIG. 2. The direction arrow in FIG. 4 indicates the lenses 401 rotate clockwise in this orientation away from the frames and upward.

FIG. 5 shows the elements of the design rotated to an approximately 50 degree angle, causing the flexible L-shaped piece 402 to rotate to a position that temporarily secures the flexible L-shaped piece 402 between the upper chassis element 407 and the cam element 408. Separation between the cam shaft or cam element 408 and the upper chassis element 407 and the shapes of these elements facilitate the movement and securing of flexible L-shaped piece 402. The result of the positioning and shaping of these elements is the ability for the user to rotate lenses 401 such that any movement from an intermediate position up or down encourages or applies force to move the lenses to either a fully open position in the case of upward movement or a fully closed position in the case of downward movement.

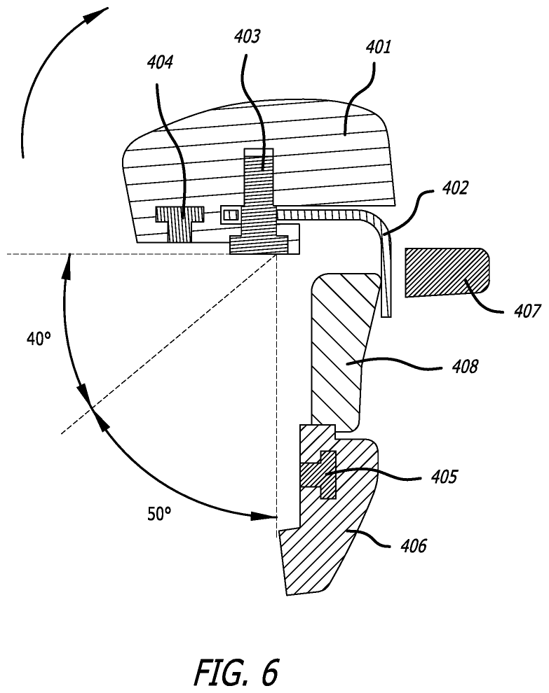

FIG. 6 illustrates complete movement to a 90 degree angle using the flexible L-shaped piece 402, where the user rotating the lenses 401 upward from an approximately 50 degree intermediate point results in rotational force, by either spring or flexible spring tension or other force producing hardware, in an upward direction opening the lenses to a full upright position as shown. Flexibility of L-shaped piece 402, together with a spring component, can provide beneficial interaction with cam 408 using the spring or flexible spring tension, but the piece again may be rigid or non-flexible while typically still employing a spring element or an element that functions to provide force. In one embodiment, a spring arrangement is provided that provides force to the L-shaped element or facia plate in both an upward and downward direction such that rotation causes application of force to or toward an open position when the pair of removable lenses are directed upward, or toward a closed position when the pair of removable lenses are directed downward. In another embodiment, the resistance of the facia plate or L-shaped element and the cam or cam shaft arrangement shown provides force upward and downward. Further, L-shape piece 402 does not typically contact upper chassis element 407 and creates no or minimal resistance.

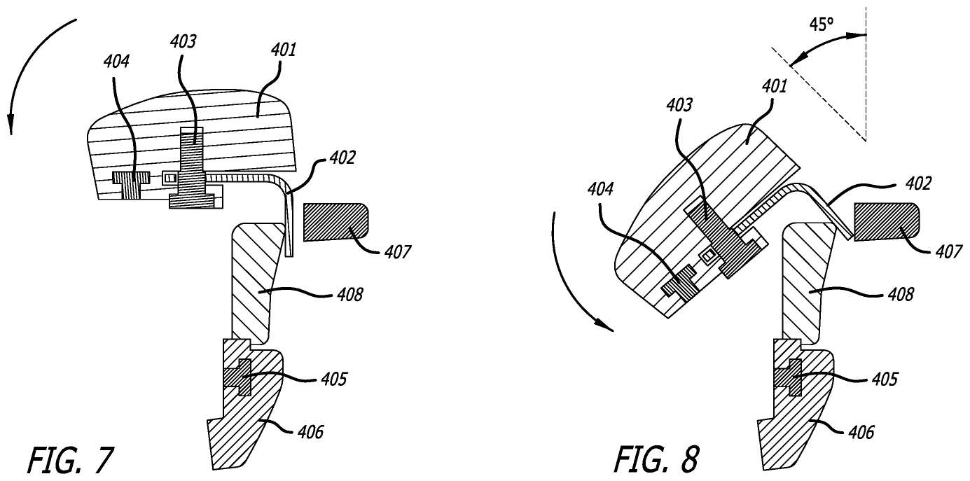

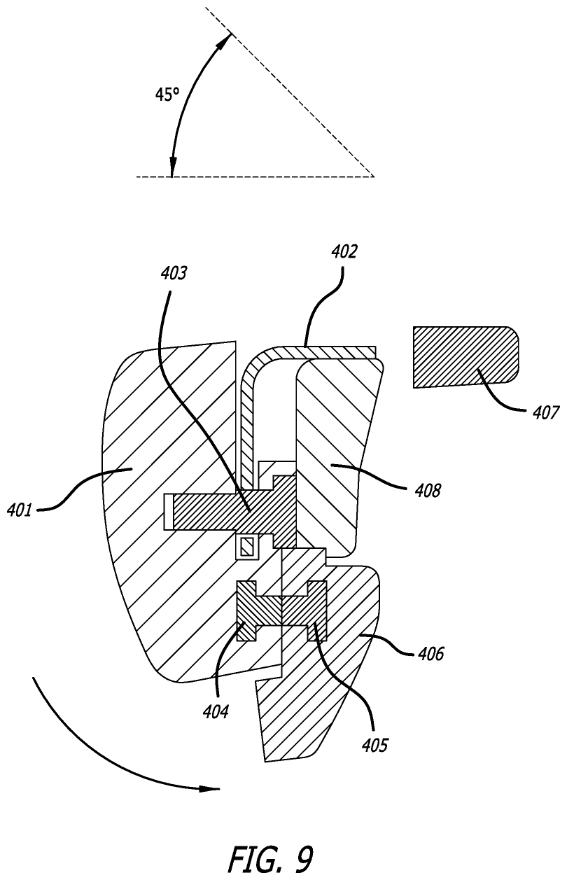

FIG. 7 is similar to FIG. 6 and as shown by the arrow is the beginning of movement of the lenses in the counterclockwise direction, starting from the 90 degree point and moving toward the intermediate point. As shown in FIG. 8, rotation counterclockwise causes pivoting of the arrangement to the intermediate position, i.e. approximately 50 degree position relative to the frames due to the interaction between the flexible L-shaped piece 402, the cam 408, and the upper chassis element 407. Again, in the position of FIG. 8, the flexible L-shaped piece 402 encounters resistance at its tip from upper chassis element 407 and at another point by cam 408, approximately 50 degrees from the frames. FIG. 9 shows the closed position, after the user has moved the lenses downward from the intermediate position and force propels the eyewear to the closed position, the flexible L-shaped piece 402 moves through the final 50 degrees, and the magnets cause the lenses 401 to be secured to the chassis or frames.

Use of cam 408 and the other elements illustrated provides the user with a simple way of putting the lenses in either the full up or full down position without the need to ratchet through multiple positions, or to employ a continuous tension mechanism that wears out after limited uses. The present design is efficient and long lasting and provides an ease of use previously unavailable, providing force upward when being directed up and downward when directed down.

While the arrangement depicted may rotate through all angles from zero to 90, the depiction of 40 and 50 degrees may vary and may differ with different cam and rotating element constructions. However, as used herein, the term “approximately 50 degrees” is intended to mean 50 degrees, plus or minus five degrees, i.e. from 45 to 55 degrees from the chassis or frame, to plus or minus two degrees, i.e. from 48 degrees to 52 degrees. Other approximate angles are intended to mean similar ranges of values.

Relationship between certain elements disclosed is as follows. The present design includes the set of removable lenses joined to a facia plate or similar device, where a rotatable element such as rotating element 202 is employed. The generally L-shaped element of FIGS. 4 through 9 may be positioned outward from the facia plate or may be formed as part of the flip-up facia plate. In general, rotation of the lenses causes rotation of the generally L-shaped element and the facia plate using the rotating element 202 pictured in FIG. 2. The screw shown in FIGS. 4 through 9 may join the support member, or support element, or generally L-shaped element to the lenses directly or may join to elements holding or maintaining the lenses. And while the generally L-shaped element is shown as being of a particular shape, different shapes of this component and/or the cam and upper chassis element may be provided while still offering the functionality described herein. For example, the support element or generally L-shaped piece may comprise two pieces joined together, may be curved differently, or may differ in shape, as long as it provides the recited movement in conjunction with the cam shaft and upper chassis assembly and joins to the pair of lenses provided.

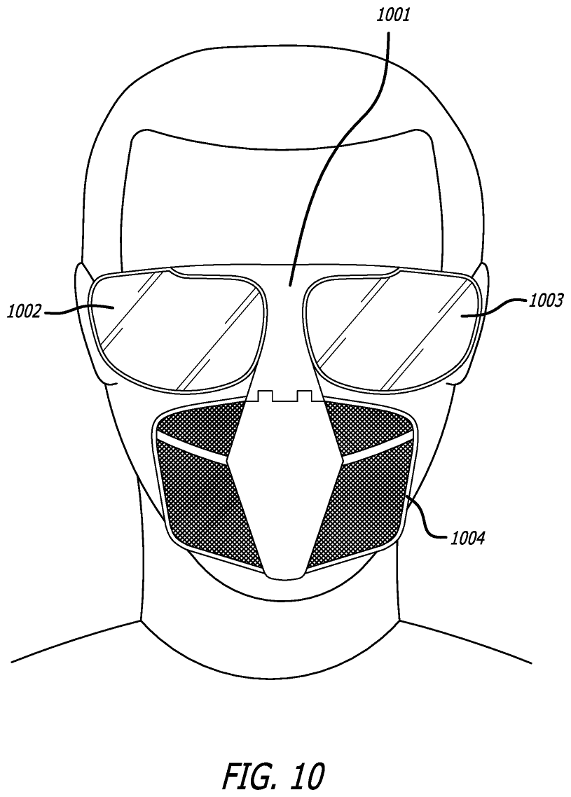

FIG. 10 includes an optional design that includes components from the previous design with an optional facia plate 1001. Lenses 1002 and 1003 are show which join to the frame or chassis in a manner similar to that discussed above such that the lenses can flip up and down with the forces described. The optional facia plate may be offered in addition to or as a substitute for other facia plates discussed above. A user may obtain a chassis or frame and may obtain lenses of differing quality and/or color as well as a facia plate as shown in FIG. 10, which may snap into the chassis and may include an element attached thereto, such as mask element 1004. Mask element 1004 may take any desired form, and may be used as a face shield, a filter, or otherwise. The depiction of FIG. 10 and the mask element 1004 shown is a filter mask, usable to filter incoming air and/or other gasses. The depiction of FIG. 10 may be constructed of plastic or some type of polymer and may be fitted with a further filtering device, such as a fabric or other fine particle filter element, in one embodiment placed behind or toward the face of the user.

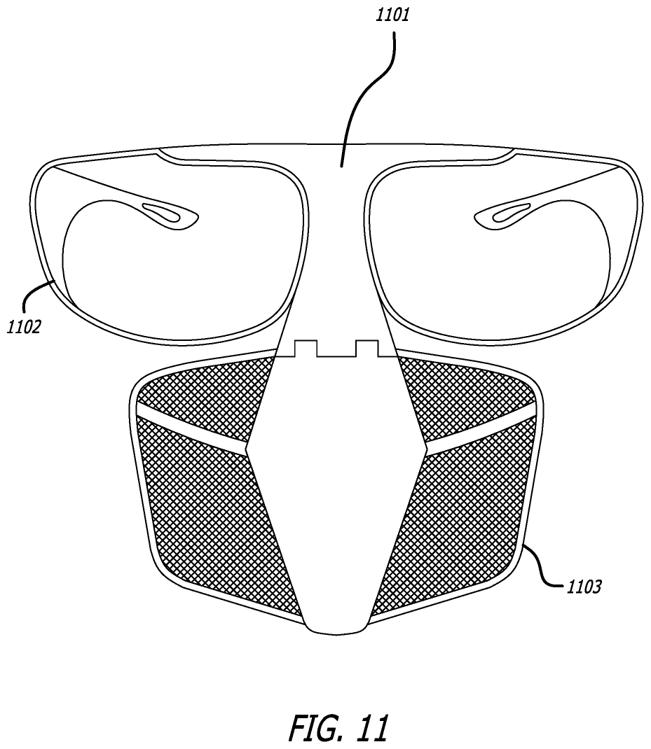

FIG. 11 is an alternate embodiment of the design including mask with no lenses provided. Lenses may be provided with the alternate facia plate 1101 or may be provided in some other fashion as appropriate, such as snapping in or otherwise attaching to alternate facia plate 1101. Shown is chassis 1102 and mask 1103, which may have fine openings or may be fitted with an item that provides for filtering of particles, such as cloth, fabric, microfiber, or other material.

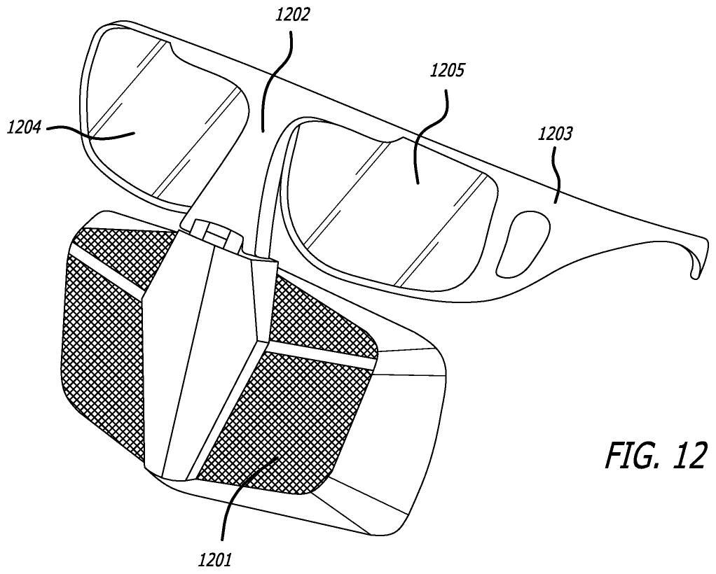

FIG. 12 is a further embodiment employing a mask element 1201, showing alternate facia plate 1202, chassis 1203, and lenses 1204 and 1205. Again, the facia plate includes the rotating element discussed above, or accepts such an element, such that the alternate facia plate 1202 can be snapped into a receiving element or arrangement on the chassis 1203. The user can raise both the mask element 1201 and the lenses 1204 and 1205 to, for example, an intermediate position. Also, lenses can be interchanged and the mask replaced on the bottom of the alternate facia plate 1202. As may be appreciated, alternate facia plate 1202 includes receiving elements (not shown in this view), similar to those provided on the chassis of the embodiment of FIG. 1 et seq, while the mask element 1201 may be provided with circular elements that snap into the receiving elements on the alternate facia plate 1202. The construction may be reversed, i.e. receiving elements formed on the mask and the alternate facia plate 1202 including circular elements. In either scenario, the mask element 1201 can slightly move or rotate relative to alternate facia plate 1202 when the user moves, for example. And again, a further filtering element, such as a cloth or fabric or other filtering element, may be employed.

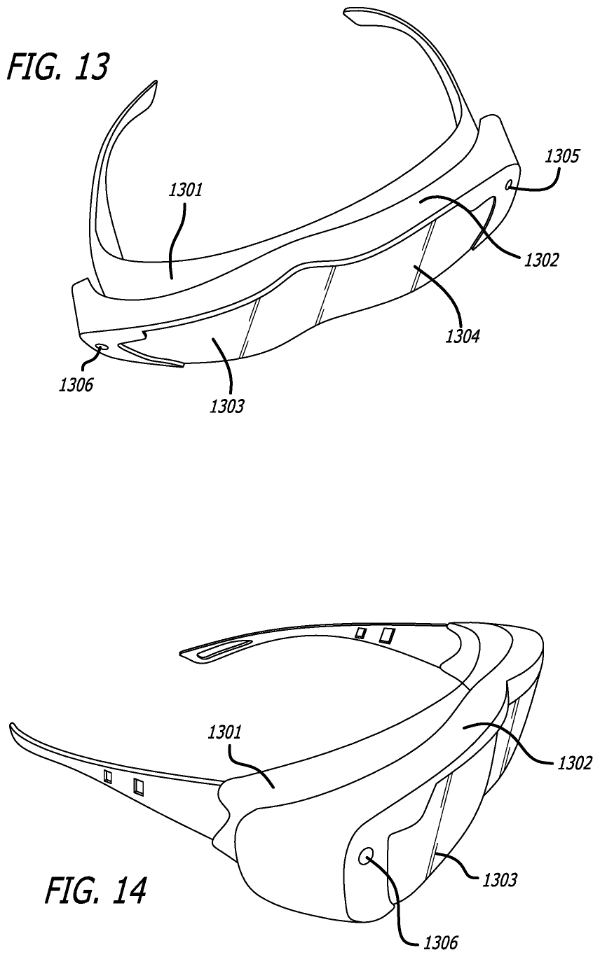

FIGS. 13 through 15 show a further embodiment including magnification lenses and lighting, such as LED lights, provided for close work and usable, as with all other embodiments, over standard prescription eyeglasses. From FIG. 13, there is provided a chassis or frame 1301 with a snap on component 1302 that includes lenses 1303 and 1304 formed as a unitary piece in this embodiment, as well as light elements 1305 and 1306. Not shown in this view is a switch that may be employed to switch light elements 1305 and 1306 on and off, as well as at least one recharging port used to charge the light elements 1305 and 1306. Light elements 1305 and 1306 may be any reasonable type of lighting element, including LED lights, and more or fewer light elements may be provided, and may be provided in other positions on the chassis or frame 1301. For example, a singular light element may be placed centrally, between the lenses 1303 and 1304.

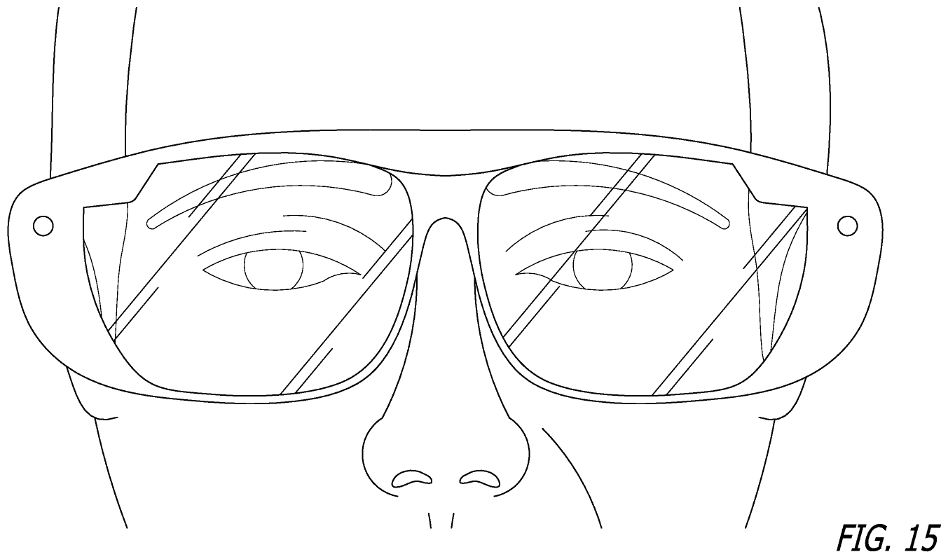

FIG. 14 is a further representation of the design, as is FIG. 15. As may be appreciated from FIGS. 13 through 15, supplemental lenses are provided and thus no lenses may be employed that snap into the chassis or frame 1301. The rotation and interchangeability of lenses provided in the embodiments of FIG. 1, for example, are not necessarily employed when this magnifying embodiment is offered, and no facia plate need be used. The snap on component 1302 simply attaches to or snaps onto the chassis or frame, providing magnification and light. However, the same chassis shown in FIG. 1 et seq. may be employed with this magnifying embodiment.

Thus according to one embodiment of the present design, there is provided eyewear comprising an eyewear chassis comprising two openings and receiving elements formed in the eyewear chassis, the receiving elements configured to firmly and securely receive a rotatable element connectable to a facia plate configured to maintain a removable pair of lenses. In some embodiments, rotating the removable pair of lenses from a fully closed position away from the eyewear chassis causes the facia plate to receive upward force to raise the removable pair of lenses to a fully open position and rotating the removable pair of lenses from the fully open position toward the eyewear chassis causes the facia plate to receive downward force to lower the removable pair of lenses to the fully closed position. In one embodiment, one lens of the removable pair of lenses fits within at least one milled recessed inner edge formed within one of the two openings when the removable pair of lenses is in the fully closed position.

According to another embodiment, there is provided eyewear for use with a removable pair of lenses comprising an eyewear chassis comprising two openings and receiving elements formed in the eyewear chassis configured to firmly and securely receive a rotatable element connectable to a facia plate configured to maintain the removable pair of lenses. In some embodiments, rotating the removable pair of lenses away from the eyewear chassis causes application of upward force to the facia plate toward a fully open position and rotating the removable pair of lenses toward the eyewear chassis causes application of downward force to the facia plate toward a fully closed position. In some embodiments, one lens of the removable pair of lenses fits within at least one recessed inner edge formed within one of the two openings when the removable pair of lenses is in the fully closed position.

According to a further embodiment of the present design, there is provided eyewear for use with a removable pair of lenses comprising an eyewear chassis comprising two openings and a cam shaft and a facia plate connected to the removable pair of lenses. In some embodiments, rotating the removable pair of lenses away from the cam shaft results in the facia plate being forced upward away from the cam shaft, and wherein rotating the removable pair of lenses toward the cam shaft results in the facia plate being forced downward toward the cam shaft. In some embodiments, one lens of the removable pair of lenses fits within at least one recessed inner edge formed within one of the two openings when the removable pair of lenses is in a fully closed position.

While the present design has been particularly shown and described with reference to some aspects or embodiments, it will be understood by those skilled in the art that various changes in form and detail may be made therein without departing from the spirit and scope of the invention.

It will be appreciated that variations of the above disclosed and other features and functions, or alternatives thereof, can be desirably combined into many other different systems or applications. Also, it will be appreciated that various presently unforeseen or unanticipated alternatives, modifications, variations or improvements therein can be subsequently made by those skilled in the art, which are also intended to be encompassed by the present design. The foregoing description of specific aspects or embodiments reveals the general nature of the disclosure sufficiently that others can, by applying current knowledge, readily modify and/or adapt the system and method for various applications without departing from the general concept. Therefore, such adaptations and modifications are within the meaning and range of equivalents of the disclosed aspects or embodiments. The phraseology or terminology employed herein is for the purpose of description and not of limitation.

What is claimed is:

1. Eyewear comprising:
an eyewear chassis comprising two openings; and
receiving elements formed in the eyewear chassis, the receiving elements configured to firmly and securely receive a rotatable element connectable to a facia plate configured to maintain a removable pair of lenses;
wherein rotating the removable pair of lenses from a fully closed position away from the eyewear chassis causes the facia plate to receive upward force to raise the removable pair of lenses to a fully open position and rotating the removable pair of lenses from the fully open position toward the eyewear chassis causes the facia plate to receive downward force to lower the removable pair of lenses to the fully closed position;
wherein one lens of the removable pair of lenses fits within at least one milled recessed inner edge formed within one of the two openings when the removable pair of lenses is in the fully closed position.

2. The eyewear of claim 1, wherein the facia plate comprises a first magnet and the eyewear comprises a second magnet opposite in polarity to the first magnet.

3. The eyewear of claim 1, further comprising a cam shaft, wherein the cam shaft and the facia plate operate such that when the removable pair of lenses is above an intermediate position upward force is applied to the facia plate and when the removable pair of lenses is below the intermediate position downward force is applied to the facia plate.

4. The eyewear of claim 3, wherein the intermediate position is approximately 50 degrees from a vertical face of the eyewear chassis.

5. The eyewear of claim 1, further comprising a screw used to join the support element to the removable pair of lenses.

6. The eyewear of claim 1, wherein movement of the removable pair of lenses from an intermediate position upward provides a level of force promoting rotation of the removable pair of lenses to the fully opened position.

7. The eyewear of claim 1, wherein movement of the removable pair of lenses from an intermediate detent position downward provides a level of force promoting rotation of the removable pair of lenses to the fully closed position.

8. Eyewear for use with a removable pair of lenses comprising:
an eyewear chassis comprising two openings; and
receiving elements formed in the eyewear chassis configured to firmly and securely receive a rotatable element connectable to a facia plate configured to maintain the removable pair of lenses;
wherein rotating the removable pair of lenses away from the eyewear chassis causes application of upward force to the facia plate toward a fully open position and rotating the removable pair of lenses toward the eyewear chassis causes application of downward force to the facia plate toward a fully closed position;
wherein one lens of the removable pair of lenses fits within at least one recessed inner edge formed within one of the two openings when the removable pair of lenses is in the fully closed position.

9. The eyewear of claim 8, wherein the facia plate comprises a first magnet and the eyewear comprises a second magnet opposite in polarity to the first magnet.

10. The eyewear of claim 8, further comprising a cam shaft, wherein the cam shaft and the facia plate operate such that when the removable pair of lenses is above an intermediate position upward force is applied to the facia plate and when the removable pair of lenses is below the intermediate position downward force is applied to the facia plate.

11. The eyewear of claim 10, wherein the intermediate position is approximately 50 degrees from a vertical face of the eyewear.

12. The eyewear of claim 8, further comprising a screw used to connect the facia plate to the removable pair of lenses.

13. The eyewear of claim 8, wherein movement of the removable pair of lenses from the intermediate position upward provides a level of force promoting rotation of the removable pair of lenses to the fully open position.

14. The eyewear of claim 8, wherein movement of the removable pair of lenses from the intermediate position downward provides a level of force promoting rotation of the removable pair of lenses to the fully closed position.

15. Eyewear for use with a removable pair of lenses comprising:
an eyewear chassis comprising two openings and a cam shaft; and
a facia plate connected to the removable pair of lenses;
wherein rotating the removable pair of lenses away from the cam shaft results in the facia plate being forced upward away from the cam shaft, and wherein rotating the removable pair of lenses toward the cam shaft results in the facia plate being forced downward toward the cam shaft;
wherein one lens of the removable pair of lenses fits within at least one recessed inner edge formed within one of the two openings when the removable pair of lenses is in a fully closed position.

16. The eyewear of claim 15, wherein the facia plate comprises a first magnet and the eyewear comprises a second magnet opposite in polarity to the first magnet.

17. The eyewear of claim 15, wherein the cam shaft and the facia plate operate such that when the removable pair of lenses is above an intermediate position upward force is applied to the facia plate and when the removable pair of lenses is below the intermediate position downward force is applied to the facia plate.

18. The eyewear of claim 17, wherein the intermediate position is approximately 50 degrees from a vertical face of the eyewear.

19. The eyewear of claim 15, wherein movement of the removable pair of lenses from an intermediate position upward provides a level of force promoting rotation of the removable pair of lenses to the fully opened position.

20. The eyewear of claim 15, wherein movement of the removable pair of lenses from an intermediate position downward provides a level of force promoting rotation of the removable pair of lenses to the fully closed position.
